(19) United States
(12) Patent Application Publication
(10) Pub. No.: US 2015/0254293 A1
(43) Pub. Date: Sep. 10, 2015

(54) INFORMATION PROCESSING METHOD, VERIFYING DEVICE, AND STORAGE MEDIUM

(71) Applicant: FUJITSU LIMITED, Kawasaki-shi (JP)

(72) Inventors: Toshihiro SHIMIZU, Sagamihara (JP); Takeshi Yasuie, Kawasaki (JP)

(21) Appl. No.: 14/616,969

(22) Filed: Feb. 9, 2015

(30) Foreign Application Priority Data
Mar. 7, 2014 (JP) 2014-045441

(51) Int. Cl. G06F 17/30; H04L 12/26

(52) U.S. Cl. CPC G06F 17/30345; H04L 43/04

(57) ABSTRACT

An information processing method to be executed by a processor included in a verifying device configured to verify a program executed by a device, the information processing method includes storing order information indicating an order in which a plurality of packets are received by the verifying device; receiving packets transmitted by the device according to the program executed by the device; and controlling a timing to transmit a response to each of the received packets based on the order information.

### CROSS-REFERENCE TO RELATED APPLICATION

This application is based upon and claims the benefit of priority of the prior Japanese Patent Application No. 2014-045441 filed on Mar. 7, 2014, the entire contents of which are incorporated herein by reference.

### FIELD

The embodiments discussed herein are related to an information processing method, a verifying device, and a storage medium.

### BACKGROUND

Conventionally, in a production system, when a program that is executed in the system is to be updated or another program is to be newly added to the system, verification is executed by a verification system in advance. For example, in a three-layer system composed of a web server, a database (DB) server, and a client device, when a program of the web server is to be updated, whether or not an abnormality occurs in the updating is verified by a verification system composed of the same layers.

A verification system that uses captured data is known. The verification system captures packets from a production system, records the captured packets, and outputs the captured packets to a server device provided with an updated program and to be verified. Then, the verification system compares response data received from the server device to be verified with captured response data and verifies whether or not the server device operates in the same manner as the production system. As related art, Japanese Laid-open Patent Publications Nos. 2012-195699 and 2010-282266 are disclosed.

In the aforementioned technique, however, only whether or not a response to a predetermined request is transmitted is verified. Thus, when the order of packets is changed in a verification environment, it is difficult to maintain a verification process and the verification process is not executed based on the order.

The three-layer system is described below as an example. In the verification system, the order in which requests are issued by a verification web server to a verification DB server may change and be different from a production environment for some reason. In this case, the verification DB server receives the requests in a different order from captured data items. The verification DB server transmits responses according to the order in which the data items are captured. Thus, if the order in which the requests are received is different from the production environment, the responses may not be transmitted.

Even if the verification DB server transmits the responses regardless of the order in which the requests are received, whether or not data of the responses is correct may not be determined. Thus, the reliability of the verification process may be reduced.

### SUMMARY

According to an aspect of the invention, an information processing method to be executed by a processor included in a verifying device configured to verify a program executed by a device, the information processing method includes storing order information indicating an order in which a plurality of packets are received by the verifying device; receiving packets transmitted by the device according to the program executed by the device; and controlling a timing to transmit a response to each of the received packets based on the order information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overall configuration of a system according to a first embodiment;

FIG. 2 is a functional block diagram illustrating a functional configuration of a verifying device according to the first embodiment;

FIG. 3 is a diagram illustrating an example of information stored in a packet capture table;

FIG. 4 is a diagram illustrating an example of information stored in a query analysis table;

FIG. 5 is a diagram illustrating an example of information stored in a queue management table;

FIG. 6 is a diagram illustrating an example of information stored in a verification result table;

FIG. 7 is a flowchart of a process of simulating operations of client terminals;

FIG. 8 is a flowchart of a process of simulating an operation of a DB server;

FIG. 9 is a diagram describing the order of arrival of packets in observation and the order of arrival of the packets in verification;

FIG. 10 is a diagram describing a process to be executed by the verifying device according to the first embodiment;

FIG. 11 is a flowchart of a process of simulating an operation of the DB server according to a second embodiment;

FIG. 12 is a diagram describing a process to be executed by the verifying device according to the second embodiment;

FIG. 13 is a diagram describing a method for avoiding a deadlock; and

FIG. 14 is a diagram illustrating an example of a hardware configuration.

### DESCRIPTION OF EMBODIMENTS

Hereinafter, embodiments of a verification method disclosed herein, a verification program disclosed herein, and a verifying device disclosed herein are described in detail with reference to the accompanying drawings. The disclosure is not limited to the embodiments. The embodiments may be combined without any contradiction.

### First Embodiment

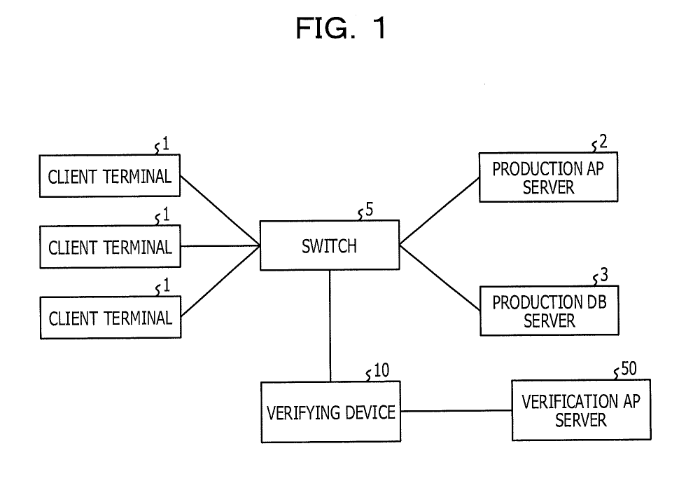

FIG. 1 is a diagram illustrating an example of an overall configuration of a system according to a first embodiment. As illustrated in FIG. 1, the system is composed of a production environment including a plurality of client terminals 1, a production application (AP) server 2, a production DB server 3, and a switch 5 and a verification environment including a verifying device 10 and a verification AP server 50. The numbers of devices in the environments are an example and are not limited to FIG. 1.

The production environment is a system that is formed by a network different from the verification environment and provides various services such as a web service to the client terminals 1. The verification environment is a verification system that is formed by a network different from the production environment. Before an update operation that is a patch operation, version upgrade, or the like is executed on the server and the like that operate in the production environment, the verification environment verifies whether or not functional features and performance features are deteriorated after the update operation.

The client terminals 1 are computers that use a web browser or the like to access the production AP server 2 and use the various services. The client terminals 1 update a database (DB) held by the production DB server 3 through the production AP server 2, for example.

The production AP server 2 receives requests from the client terminals 1 and executes a transaction on the production DB server 3. The production AP server 2 may have a function as a web application server configured to accumulate HTML documents and the like and provide the web service.

For example, the production AP server 2 executes applications corresponding to the requests received from the client terminals 1. The production AP server 2 transmits the requests to the production DB server 3. The production AP server 2 receives responses to the requests from the production DB server 3 and transmits the responses to the client terminals 1.

The production DB server 3 has the database. The production DB server 3 updates the database and the like in response to the requests received from the production AP server 2. Then, the production DB server 3 transmits results of the update as responses to the production AP server 2. As the database included in the production DB server 3, a relationship database, an object database, a key-value store (KVS) database, or the like may be used.

The switch 5 is a data relay device coupled to the production AP server 2, the production DB server 3, and the client terminals 1 through ports and configured to switch communication between the client terminals 1, the production AP server 2, and the production DB server 3. For example, as the switch 5, a switching hub, a router, a tap, or the like may be used. The switch 5 executes port mirror switching. The switch 5 transfers data received from the production AP server 2, the production DB server 3, and the client terminals 1 to the verifying device 10.

The verification environment is an environment configured to connect, to the verifying device 10, the server operating in the production environment or a server to be newly connected to the production environment as a server to be verified. The verification is executed when the performance after the aforementioned update is to be confirmed, or when the server is to be relocated, or the like. For example, when the aforementioned production environment is operated within a company and only the production AP server 2 is to be transitioned to a cloud environment provided by a system integrator or the like, the verification is executed. In this case, the verifying device 10 verifies the verification AP server 50 having the same functions as the production AP server 2.

As an example, it is assumed that the production AP server 2 is to be verified and the verification environment includes the verification AP server 50. The verification AP server 50 is a server to be verified and has the same functions as the production AP server 2. The verification AP server 50 is coupled to the verifying device 10. In the verification AP server 50, an Internet Protocol (IP) address of the verifying device 10 with which the verification AP server 50 directly communicates is set as addresses of the client terminals 1 and production DB server 3 that are not to be verified.

The verification environment simulates operations of the client terminals 1 and an operation of the production DB server 3 and verifies an operation of the production AP server 2. A casing in which a verifying device configured to simulate the operations of the client terminals 1 is stored may be different from a casing in which a verifying device configured to simulate the operation of the production DB server 3 is stored.

The verification AP server 50 executes the same transaction as an actual transaction processed by the production AP server 2 of the production environment and transmits data to the verifying device 10. When receiving a packet from the verifying device 10, the verification AP server 50 transmits response data corresponding to data of the packet to the verifying device 10.

The verifying device 10 receives a packet from the verification AP server 50 that is a device to be verified. The verifying device 10 determines whether to transmit a response to the received packet to the verification AP server 50 based on a control list including information on the order in which the verifying device 10 transmits responses to the verification AP server 50. After that, if the verifying device 10 determines that the response is to be transmitted, the verifying device 10 transmits the response to the verification AP server 50. On the other hand, if the verifying device 10 determines that the response is not to be transmitted, the verifying device 10 stands by until it becomes possible to transmit the response to the received packet. When it becomes possible to transmit the response to the received packet, the verifying device 10 transmits the response to the verification AP server 50.

For example, the verifying device 10 uses port mirroring of the switch 5 or the like to capture and hold packets of the production environment. When the verification AP server 50 is to be verified, the verifying device 10 does not transmit responses in the order of arrival of requests received from the verification AP server 50 in the verification environment and transmits the responses in the order of arrival of the requests observed in the production environment. As a result, the verifying device 10 may execute the verification based on the order of packets.

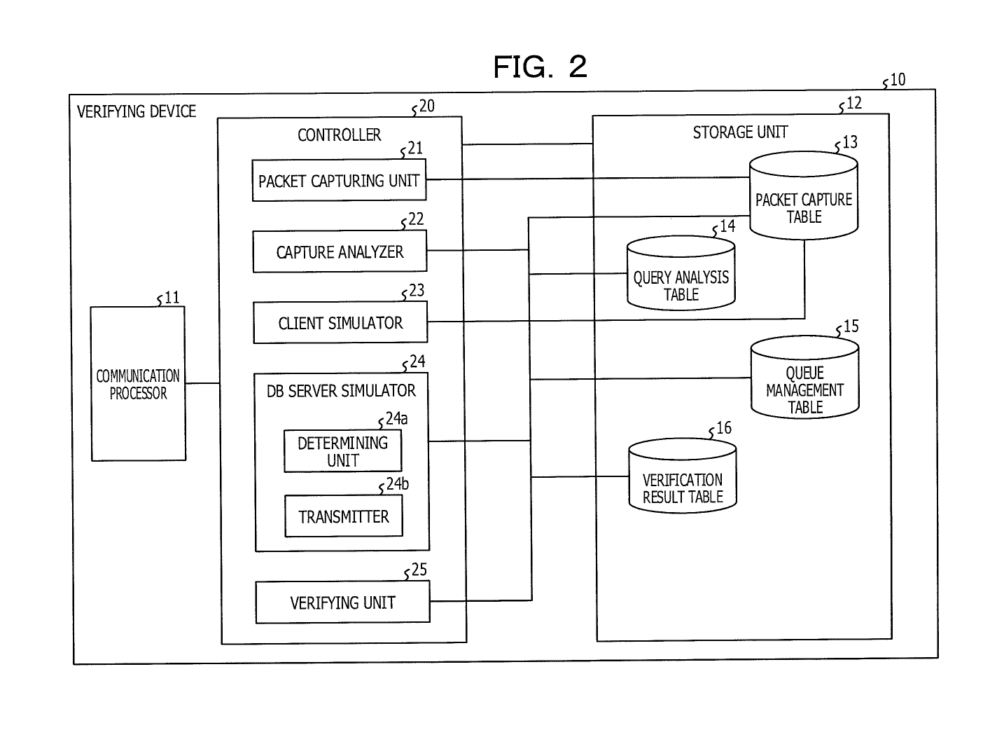

FIG. 2 is a functional block diagram illustrating a functional configuration of the verifying device according to the first embodiment. As illustrated in FIG. 2, the verifying device 10 includes a communication processor 11, a storage unit 12, and a controller 20.

The communication processor 11 includes one or more ports and controls communication between the verifying device 10 and the verification AP server 50. The communication processor 11 controls communication between the verifying device 10 and the switch 5.

IP addresses to be used in the production environment and IP addresses of the devices that are not verified are set in the ports of the communication processor 11. In the example illustrated in FIG. 1, an IP address for the production environment is set in a first port of the communication processor 11. An IP address to be used for the production DB server 3 is set in a second port of the communication processor 11. IP addresses to be used for the client terminals 1 are set in a third port of the communication processor 11.

The storage unit 12 is a storage device such as a memory or a hard disk. The storage unit 12 stores a packet capture table 13, a query analysis table 14, a queue management table 15, and a verification result table 16.

The packet capture table 13 holds actually captured data obtained by capturing a packet within the production environment including the plurality of devices. Specifically, the packet capture table 13 stores packet information generated in a transaction executed in the production environment. Data captured by a packet capturing unit 21 (described later) at predetermined time intervals of a day, a week, or the like is stored in the packet capture table 13.

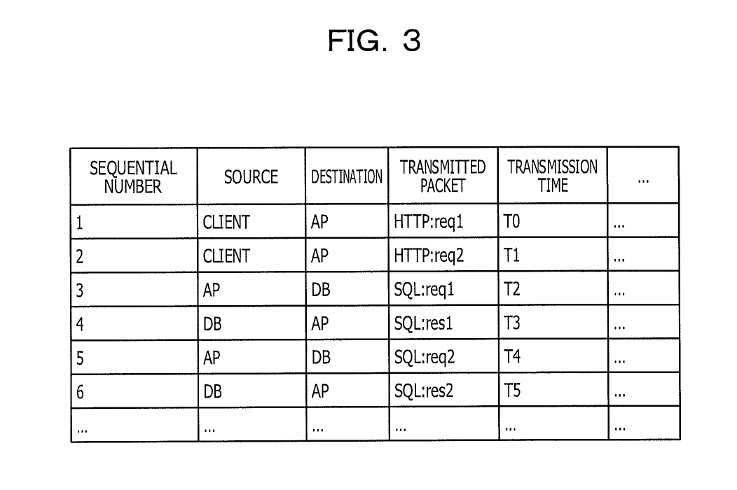

FIG. 3 is a diagram illustrating an example of the information stored in the packet capture table. As illustrated in FIG. 3, “sequential numbers”, “sources”, “destinations”, “transmitted packets”, “transmission times”, and the like are associated and stored in the packet capture table 13.

The stored “sequential numbers” indicate the order in which packets are captured. The “sources” indicate sources that transmit the captured packets. The “destinations” indicate destinations of the captured packets. The “transmission times” indicate times when the captured packets are transmitted. The packet capture table 13 may hold the captured packets associated with the aforementioned information. The packet capture table 13 may store, as information other than the aforementioned information, the types of the packets, information indicating success or failure of a process, and the like.

In the example illustrated in FIG. 3, a first row indicates that HTTP:req1 is transmitted from a client terminal 1 to the production AP server 2 at a time T0 and captured. A second row indicates that HTTP:req2 is transmitted from a client terminal 1 to the production AP server 2 at a time T1 and captured. A third row indicates that SQL:req1 is transmitted from the production AP server 2 to the production DB server 3 at a time T2 and captured. A fourth row indicates that SQL:res1 is transmitted from the production DB server 3 to the production AP server 2 at a time T3 and captured. Req stands for a request and res stands for a response.

The query analysis table 14 stores information of packets transmitted to the production DB server 3. Specifically, the query analysis table 14 stores information on Structured Query Language (SQL) statements issued to the production DB server 3 in the production environment.

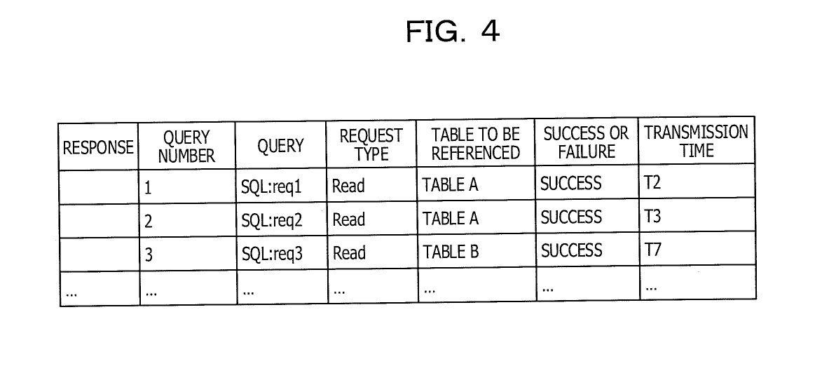

FIG. 4 is a diagram illustrating an example of the information stored in the query analysis table. As illustrated in FIG. 4, “responses”, “query numbers”, “queries”, “request types”, “tables to be referenced”, “success or failure”, and “transmission times” are associated and stored in the query analysis table 14. This information is generated by a capture analyzer 22 (described later).

The stored “responses” are information indicating whether or not data is transmitted as responses in the verification environment. If a response is transmitted, an interested “response” of the query analysis table 14 is checked. The “query numbers” indicate the order in which queries are generated in the production environment. The “queries” indicate the queries generated in the production environment, and details of SQL statements are set as the “queries”, for example. The “request types” are the type of the issued SQL statements, and read or write is set as each of the “request types”. The “tables to be referenced” are information indicating tables against which the issued SQL statements are executed. The “success or failure” indicates success or failure of the issued SQL statements. If an SQL statement is successful, “success” is set. If the SQL statement fails, “failure” is set. The “transmission times” are times when the SQL statements are issued in the production environment.

In the example illustrated in FIG. 4, the verification is not executed for any of the queries in the verification environment. In the example illustrated in FIG. 4, the queries “SQL:req1”, “SQL:req2”, and “SQL:req3” are issued in the order of the query numbers 1, 2, and 3 and the verification is executed. Then, “SQL:req1” is a query to read a table A and is successfully executed at a time T2 in the production environment.

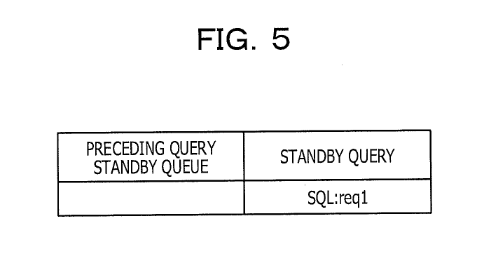

The queue management table 15 is used to manage the state of a queue holding a packet to be transmitted to the verification AP server 50 in the verification environment. FIG. 5 is a diagram illustrating an example of the information stored in the queue management table. The information stored in the queue management table is updated at any time. As illustrated in FIG. 5, a “preceding query standby queue” and a “standby query” are associated with each other and stored in the queue management table 15.

The stored “preceding query standby queue” indicates a string of a query that does not arrive in the verification environment. The “standby query” indicates a query that is yet to arrive in the verification environment at a current time and will be received next. FIG. 5 illustrates the example in which there is no query that does not arrive in the verification environment. FIG. 5 illustrates the example in which the query with the query name “SQL:req1” is to be transmitted next.

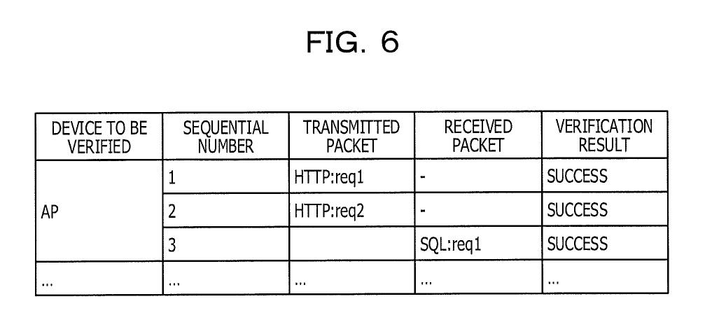

The verification result table 16 stores results of a verification process executed on the verification AP server 50. FIG. 6 is a diagram illustrating an example of the information stored in the verification result table. As illustrated in FIG. 6, a “device to be verified”, “sequential numbers”, “transmitted packets”, a “received packet”, and “verification results” are associated and stored in the verification result table 16.

The stored “device to be verified” indicates a device to be subjected to the verification process. In the present embodiment, the device to be verified is the verification AP server 50. The “sequential numbers” indicate the order in which packets are verified, while the order indicated by the “sequential numbers” is the same as the order indicated by the sequential numbers stored in the packet capture table 13. The “transmitted packets” indicate packets transmitted in the verification process. The “received packet” indicates a packet received in the verification process. The “verification results” indicate results of the verification process. If a packet that is the same as the production environment is transmitted and received, “success” is set in the verification result. If the packet that is the same as the production environment is either transmitted or received or is neither transmitted nor received, “failure” is set in the verification result.

FIG. 6 illustrates results of the verification process executed on the verification AP server 50. In the verification process, “HTTP:req1” is transmitted first. Then, “HTTP:req2” is transmitted next. After that, “SQL:req1” is received. The order illustrated in FIG. 6 is the same as the production environment, and the results of the verification process indicate that “HTTP:req1”, “HTTP:req2”, and “SQL:req1” are successful.

The controller 20 is a processor or the like, for example. The controller 20 includes the packet capturing unit 21, the capture analyzer 22, a client simulator 23, a DB server simulator 24, and a verifying unit 25. The processing units of the controller 20 are an example of processes to be executed by an electronic circuit or a processor.

The packet capturing unit 21 is a processing unit configured to capture, through the switch 5, packets actually transmitted and received in the production environment and cause the captured packets to be stored in the packet capture table 13. For example, it is assumed that a client terminal 1 accesses the production AP server 2 and the production AP server executes an application and thereby accesses the production DB server 3.

In this case, the packet capturing unit 21 captures a packet transmitted by the client terminal 1 to the production AP server 2 and indicating a request to process the DB. Next, the packet capturing unit 21 captures a packet transmitted by the production AP server 2 to the production DB server 3 and indicating a DB request. Subsequently, the packet capturing unit 21 captures a packet transmitted by the production DB server 3 to the production AP server 2 and indicating a DB response. Lastly, the packet capturing unit 21 captures a packet transmitted by the production AP server 2 to the client terminal 1 and indicating a response to the request to process the DB.

Specifically, the packet capturing unit 21 captures the packets in the order in which the packets are actually generated by transactions executed in the production environment and causes information of the captured packets to be stored in the packet capture table 13. The packet capturing unit 21 may cause the captured packets to be stored in the packet capture table 13.

The capture analyzer 22 is a processing unit configured to extract a packet issued to the production DB server 3 from the information of the captured packets. Specifically, the capture analyzer 22 references information stored in the packet capture table 13 and extracts an SQL statement issued by the production AP server 2 to the production DB server 4. Then, the capture analyzer 22 extracts, for the extracted SQL statement, a table to be referenced, a request type, information indicating success or failure, a transmission time, and the like. After that, the capture analyzer 22 causes the extracted information to be stored in the query analysis table 14.

The capture analyzer 22 may execute the aforementioned process when the verifying unit 25 instructs the capture analyzer 22 to start the verification process or when information is stored in the packet capture table 13. A time when the capture analyzer 22 executes the aforementioned process may be set to an arbitrary time. If the capture analyzer 22 may execute the aforementioned process when the verifying unit 25 instructs the capture analyzer 22 to start the verification process, the capture analyzer 22 notifies the client simulator 23 and the DB server simulator 24 of the completion of the analysis.

The client simulator 23 is a processing unit configured to simulate operations of the client terminals 1 in the production environment. Specifically, when the verification process is started, the client simulator 23 references the packet capture table 13 and transmits HTTP:req transmitted by the client terminals 1 to the verification AP server 50. The client simulator 23 receives HTTP:res from the verification AP server 50.

Then, the client simulator 23 outputs, to the verifying unit 25, information indicating that HTTP:req has been transmitted, a time when HTTP:req has been transmitted, information indicating that HTTP:res has been received, and a time when HTTP:res has been received.

For example, in the example illustrated in FIG. 3, after the client simulator 23 transmits HTTP:req1 to the verification AP server 50 and a time of (T1−T0) elapses, the client simulator 23 transmits HTTP:req2 to the verification AP server 50.

The DB server simulator 24 includes a determining unit 24a and a transmitter 24b. The DB server simulator 24 is a processing unit that uses the determining unit 24a and the transmitter 24b to simulate an operation of the production DB server 3 in the production environment.

The determining unit 24a is a processing unit configured to determine whether a response to a packet received from the verification AP server 50 to be verified is to be transmitted when the determining unit 24a receives the packet from the verification AP server 50. Specifically, when receiving an SQL statement from the verification AP server 50 to be verified, the determining unit 24a references the query analysis table 14 or queue management table 15 that includes information on the order that a result of the execution of the received SQL statement is transmitted to the verification AP server 50. Then, the DB server simulator 24 determines whether the response is to be transmitted to the verification AP server 50.

For example, when the verification process is started, the determining unit 24a refers the query analysis table 14 and identifies a query with the smallest query number among queries that are yet to be received and for which responses are yet to be transmitted. Then, the determining unit 24a causes the name of the query corresponding to the specified query number or the like to be stored in the standby query of the queue management table 15 and manages the state of the queue.

In this state, when receiving a new query from the verification AP server 50, the determining unit 24a determines whether the new query matches the standby query of the queue management table 15. Then, if the determining unit 24a determines that the new query matches the standby query of the queue management table 15, the determining unit 24a determines that a response is to be transmitted and the determining unit 24a outputs information of the new query to the transmitter 24b. After that, the determining unit 24a identifies a next standby query in the same manner as the aforementioned method and causes the name of the identified query or the like to be stored in the standby query of the queue management table 15.

On the other hand, if the new query does not match the standby query, the determining unit 24a determines that the response is not to be transmitted. Then, the determining unit 24a causes the name of the received new query or the like to be stored in the preceding query standby queue of the queue management table 15.

After that, when receiving a query from the verification AP server 50, the determining unit 24a determines whether the received query matches the standby query of the queue management table 15. If the received query matches the standby query of the queue management table 15, the determining unit 24a determines that a response is to be transmitted and the determining unit 24a outputs information of the received query to the transmitter 24b. Subsequently, the determining unit 24a causes information of a top query among queries stored in the preceding query standby queue of the queue management table 15 to be stored in the standby query.

On the other hand, if the received query does not match the standby query, the determining unit 24a determines that the response is not to be transmitted. Then, the determining unit 24a causes the information of the received query to be stored at the back of the last query stored in the preceding query standby queue so as to ensure that queries are arranged in the order in which the queries are stored.

In this manner, the determining unit 24a uses the queue management table 15 to manage the state of the standby query and determines whether the order in which queries are received from the verification AP server 50 is the same as the order in which the queries are received in the production environment. In this manner, the determining unit 24a transmits and receives packets in the same order as the production environment in the verification and executes the verification process.

The transmitter 24b is a processing unit configured to transmit, to the verification AP server 50, a response to a query determined by the determining unit 24a to be transmitted. Specifically, when receiving information of a query determined by the determining unit 24a to be transmitted, the transmitter 24b references the packet capture table 13 and identifies a response to the query. After that, the transmitter 24b transmits the identified response to the query to the verification AP server 50. In addition, the transmitter 24b outputs, to the verifying unit 25, information indicating that the query has been received, information of the received query, information of the transmitted response to the query, and the like.

The verifying unit 25 is a processing unit configured to start the verification process in accordance with an instruction operation by a user, receive verification results from the processing units, and generate the verification result table 16. Specifically, when receiving an instruction to start the verification process, the verifying unit 25 instructs the capture analyzer 22, the client simulator 23, the DB server simulator 24, and the like to start the verification process.

After that, the verifying unit 25 receives, from the client simulator 23, information on an HTTP request transmitted by the client simulator 23 and an HTTP response received by the client simulator 23. Similarly, the verifying unit 25 receives, from the DB server simulator 24, information on an SQL request received by the DB server simulator 24 and an SQL response transmitted by the DB server simulator 24.

Then, the verifying unit 25 causes the received information to be stored in the verification result table 16 and determines whether the same information as the production environment has been transmitted and received in the verification environment. If the verifying unit 25 determines that the same information as the production environment has been transmitted and received in the verification environment, the verifying unit 25 causes “success” to be stored in a verification result of the verification result table 16. On the other hand, if the verifying unit 25 determines that information that is different from the production environment has been transmitted and received in the verification environment, the verifying unit 25 causes “failure” to be stored in the verification result of the verification result table 16. In this manner, the verifying unit 25 determines whether the same information as the production environment has been transmitted and received in the verification environment and the verifying unit 25 causes a result of the determination to be stored in the verification result table 16.

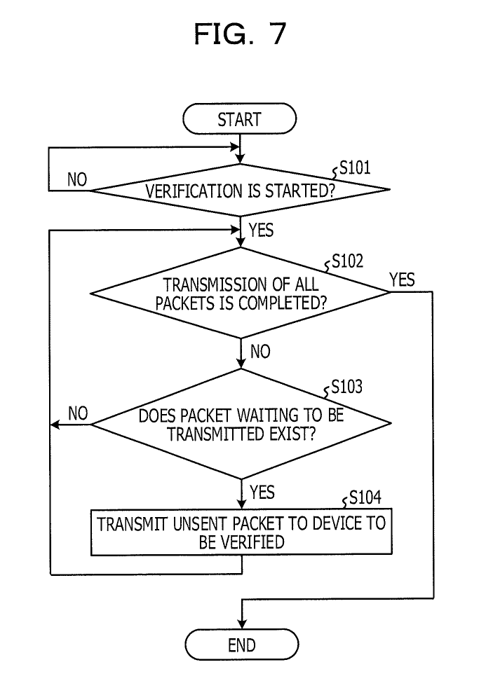

FIG. 7 is a flowchart of a process of simulating operations of the client terminals. As illustrated in FIG. 7, when the verifying unit 25 instructs the client simulator 23 to start the verification process (Yes in S101), the client simulator 23 determines whether the transmission of all packets captured through the switch 5 to the verification AP server 50 has been completed (in S102).

When the client simulator 23 determines that the transmission of all the packets to the verification AP server 50 has been completed (Yes in S102), the client simulator 23 terminates the process.

On the other hand, when the client simulator 23 determines that the transmission of all the packets to the verification AP server 50 has not been completed (No in S102), the client simulator 23 references the packet capture table 13 and determines whether a packet that waits to be transmitted exists (in S103).

When the client simulator 23 determines that the packet that waits to be transmitted exists (Yes in S103), the client simulator 23 simulates operations of the client terminals 1 and transmits the packet to the verification AP server 50 to be verified (in S104). Specifically, the client simulator 23 generates, for the verification environment, a transaction that is the same as the production environment. After that, the process returns to the process of S102.

Then, when the client simulator 23 processes all packets of the packet capture table 13 by transmitting the packets to the verification AP server 50 (Yes in S102), the client simulator 23 terminates the process.

On the other hand, when the client simulator 23 determines that the packet that waits to be transmitted does not exist (No in S103), the client simulator 23 repeats the processes of S102 and later.

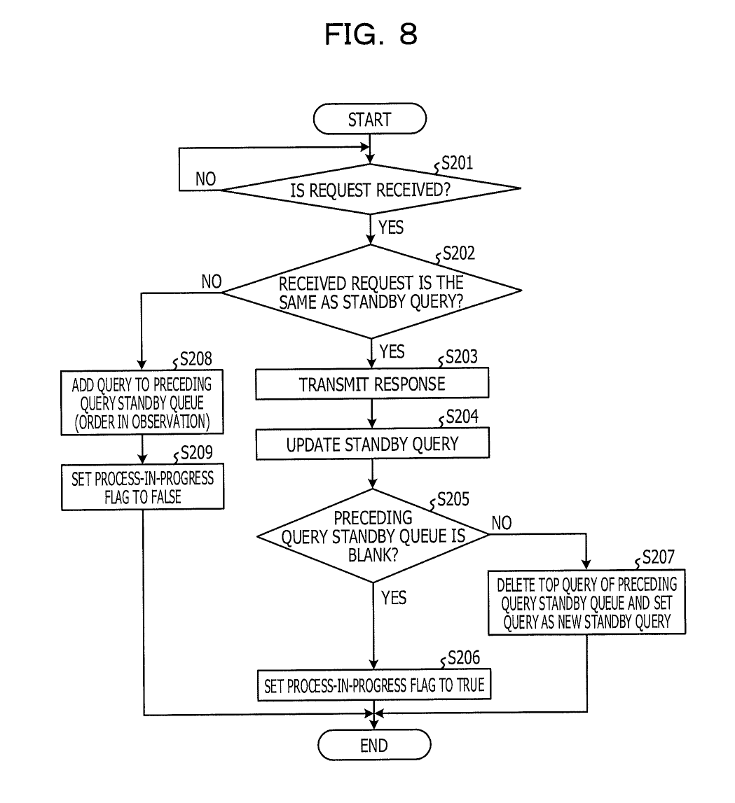

FIG. 8 is a flowchart of a process of simulating an operation of the DB server. As illustrated in FIG. 8, when receiving a request from the verification AP server 50 (Yes in S201), the determining unit 24a of the DB server simulator 24 determines whether the received request is the same as the standby query of the queue management table 15 (in S202).

When the determining unit 24a determines that the received query is the same as the standby query (Yes in S202), the transmitter 24b identifies a response corresponding to the received query from the packet capture table 13 and transmits the response to the verification AP server 50 (in S203).

After that, when the transmitter 24b transmits the request, the determining unit 24a updates the standby query of the queue management table 15 (in S204). For example, the determining unit 24a checks a “response” for the query corresponding to the transmitted request in the query analysis table 14. Furthermore, the determining unit 24a identifies a query to be received next in accordance with an analysis result stored in the query analysis table 14. Then, the determining unit 24a causes the identified query to be stored in the standby query of the queue management table 15.

Subsequently, the determining unit 24a determines whether the preceding query standby queue of the queue management table 15 is blank (in S205). When the determining unit 24a determines that the preceding query standby queue of the queue management table 15 is blank (Yes in S205), the determining unit 24a sets a process-in-progress flag to true (in S206). Specifically, the determining unit 24a determines that requests (SQL statements) are received in the same order as the production environment. The process-in-progress flag is stored in a memory or the like and updated by the determining unit 24a at any time. Then, the process is terminated.

On the other hand, when the determining unit 24a determines that one or more queries are stored in the preceding query standby queue of the queue management table 15 (No in S205), the determining unit 24a deletes a top query among the queries stored in the preceding query standby queue and registers the query as a new standby query (in S207). Then, the process is terminated.

When the determining unit 24a determines that the received query is not the same as the standby query (No in S202), the determining unit 24a causes the received query to be stored in the preceding query standby queue of the queue management table (in S208). Subsequently, the determining unit 24a sets the process-in-progress flag to false (in S209) and terminates the process.

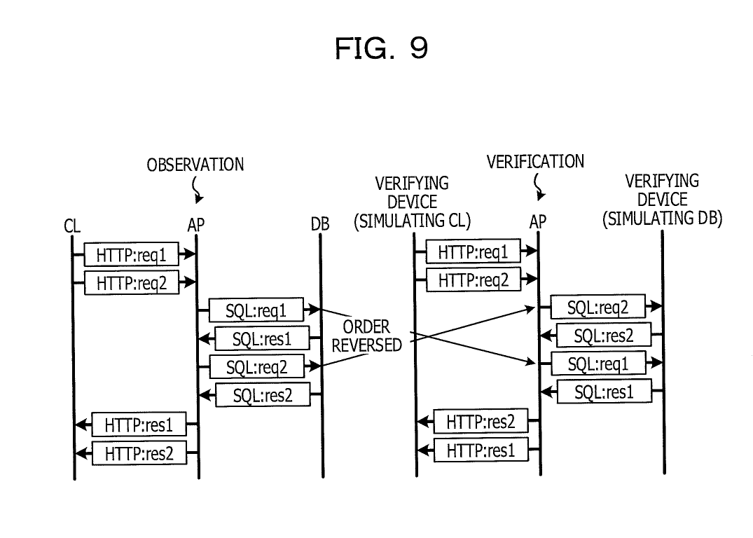

An example in which the order in which packets arrive in observation is different from the order in which the packets arrive in the verification is described below. FIG. 9 is a diagram describing the order in which the packets arrive in the observation and the order in which the packets arrive in the verification. In FIG. 9, a client terminal 1 is represented by CL, the AP servers are represented by AP, and the DB server is represented by DB.

As illustrated in FIG. 9, in the observation or packet capturing, the client terminal 1 transmits HTTP:req1 to the production AP server 2 and transmits HTTP:req2 to the production AP server 2 after the transmission of HTTP:req1.

After receiving the aforementioned two HTTP requests, the production AP server 2 transmits SQL:req1 to the production DB server 3. Then, the production DB server 3 transmits SQL:res1 to the production AP server 2. Subsequently, the production AP server 2 transmits SQL:req2 to the production DB server 3. Then, the production DB server 3 transmits SQL:res2 to the production AP server 2.

After that, when receiving the responses to the aforementioned two SQL requests, the production AP server 2 transmits, to the client terminal 1, HTTP:res1 as a response to HTTP:req1. After that, the production AP server 2 transmits, to the client terminal 1, HTTP:res2 as a response to HTTP:req2.

In the verification, after HTTP:req1 is transmitted to the verification AP server 50 from the verifying device 10 that simulates an operation of the client terminal 1, HTTP:req2 is transmitted to the verification AP server 50 from the verifying device 10.

After receiving the aforementioned two HTTP requests, the verification AP server 50 transmits SQL:req2 to the verifying device 10 that simulates an operation of the production DB server 3. Then, the verifying device 10 transmits SQL:res2 to the verification AP server 50. Subsequently, the verification AP server 50 transmits SQL:req1 to the verifying device 10. Then, the verifying device 10 transmits SQL:res1 to the verification AP server 50.

After that, when receiving the responses to the aforementioned two SQL requests, the verification AP server 50 sequentially transmits HTTP:res2 and HTTP:res1 to the verifying device 10 that simulates the operation of the client terminal 1.

When both cases are compared with each other, the order in which the HTTP requests are transmitted from the client terminal 1 to the production AP server 2 in the observation is the same as the order in which the HTTP requests are transmitted from the verifying device 10 simulating the client terminal 1 to the verification AP server 50 in the verification. However, the order in which the SQL requests are transmitted from the production AP server 2 to the production DB server 3 in the observation is different from the order in which the SQL requests are transmitted from the verification AP server 50 to the verifying device 10 simulating the production DB server 3 in the verification. Thus, the order in which the SQL responses are transmitted from the production DB server 3 to the production AP server 2 in the observation is different from the order in which the SQL responses are transmitted from the verifying device 10 simulating the production DB server 3 to the verification AP server 50 in the verification. In addition, the order in which the HTTP responses are transmitted from the production AP server 2 to the client terminal 1 in the observation is different from the order in which the HTTP responses are transmitted from the verification AP server 50 to the verifying device 10 simulating the client terminal 1 in the verification.

In the case where the verification results described with reference to FIG. 9 are obtained, the verifying device 10 receives the responses to the requests, but the order in which the verifying device 10 receives the responses may be different from the order in the observation. In this case, the verifying device 10 may not determine that the cause of the different order is an internal process of the verification AP server 50, a network between the verifying device 10 and the verification AP server 50, or another cause. Thus, the verifying device 10 may not determine results of the verification process.

Thus, even if the order in which the verifying device 10 according to the first embodiment receives requests from the verification AP server 50 is different from the order in which the requests are received in the observation, the verifying device 10 according to the first embodiment transmits responses after the order in the verification becomes different from the order in the observation. Specifically, even if the order of arrival of packets changes, the verifying device 10 reproduces a verification process in which a simple test is achieved with semantically correct operations by comparison with results of observation.

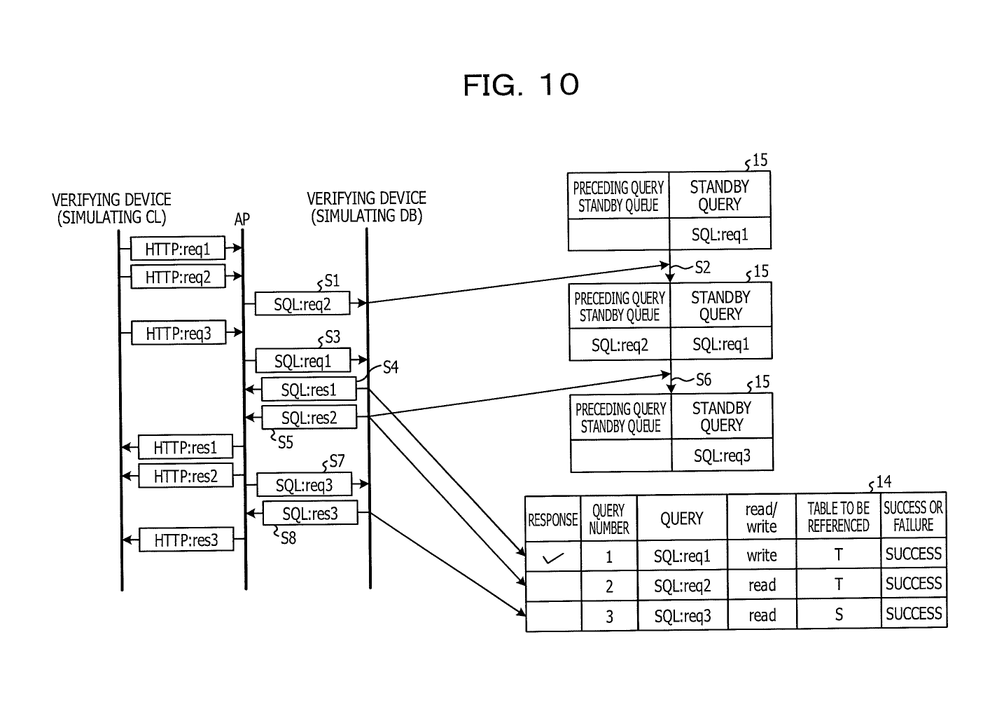

Next, a specific example of a process to be executed by the verifying device 10 in a case where the order in which requests arrive in the verification is different from the order in which the requests arrive in the observation is described. FIG. 10 is a diagram describing the process to be executed by the verifying device according to the first embodiment. Although query names or the like are registered in the queue management table 15, the query names are indicated by queries in the following description. The following description, however, assumes that the queries may not indicate the queries themselves and may indicate the query names.

As illustrated in FIG. 10, the verifying device 10 references the query analysis table 14 and stores “SQL:req1” in the standby query of the queue management table 15. In this state, the verifying device 10 receives “SQL:req2” from the verification AP server 50 (in S1).

Since the standby query “SQL:req1” of the queue management table 15 does not match the received query “SQL:req2”, the verifying device 10 stores the received query “SQL:req2” in the preceding query standby queue of the queue management table 15 (in S2). Specifically, since the received query does not match the standby query, the verifying device 10 determines that the order of arrival of the requests changes and the verifying device 10 suppresses the transmission of responses to the queries.

After that, the verifying device 10 receives “SQL:req1” from the verification AP server 50 (in S3). Since the standby query “SQL:req1” of the queue management table 15 matches the received query “SQL:req1”, the verifying device 10 transmits a response “SQL:res1” to the received query “SQL:req1” to the verification AP server 50 (in S4). Then, the verifying device 10 sets a flag in a “response” corresponding to the query “SQL:req1” of the query analysis table 14.

The verifying device 10 moves “SQL:req2” stored in the preceding query standby queue to the standby query of the queue management table 15. However, since “SQL:req2” is already received, the verifying device 10 subsequently transmits a response “SQL:res2” to “SQL:req2” to the verification AP server 50 (in S5). Then, the verifying device 10 sets a flag in a “response” corresponding to the query “SQL:req2” of the query analysis table 14.

After that, the verifying device 10 references the query analysis table 14 and stores “SQL:req3” as a next standby query in the standby query of the queue management table 15 (in S6). In this state, the verifying device 10 receives “SQL:req3” from the verification AP server 50 (in S7).

Since the standby query “SQL:req3” of the queue management table 15 matches the received query “SQL:req3”, the verifying device 10 transmits a response “SQL:res3” to the received query “SQL:req3” to the verification AP server 50 (in S8). Then, the verifying device 10 sets a flag in a “response” corresponding to the query “SQL:req3” of the query analysis table 14.

In this manner, the verifying device 10 uses the queue management table 15 and the query analysis table 14 to manage a query to be received next. Thus, the verifying device 10 determines whether responses to received queries are to be transmitted, and the verifying device 10 may transmit the responses in the same order as the observation. Thus, even if the order of arrival of packets changes, the verifying device 10 may reproduce the verification process in which the simple test is achieved with the semantically correct operations by the comparison with the results of the observation, and the verifying device 10 may execute the verification process based on the order of the arrival.

### Second Embodiment

The first embodiment describes the example in which when the order in which requests arrive in the verification is different from the order in which the requests arrive in the observation, responses are transmitted after the arrival of the requests so that the order in which the responses are transmitted in the verification is the same as the order in which the responses are transmitted in the observation. The disclosure, however, is not limited to this. For example, if an unreceived preceding query does not affect a succeeding query, the verifying device 10 may transmit a response to the received succeeding query without waiting for the reception of the preceding query.

A second embodiment describes an example in which the verifying device 10 determines whether an unreceived preceding query affects a succeeding query and the verifying device 10 transmits a response to the received succeeding query without waiting for the reception of the preceding query. A functional configuration of the verifying device 10 is the same as or similar to the first embodiment and therefore not described in detail.

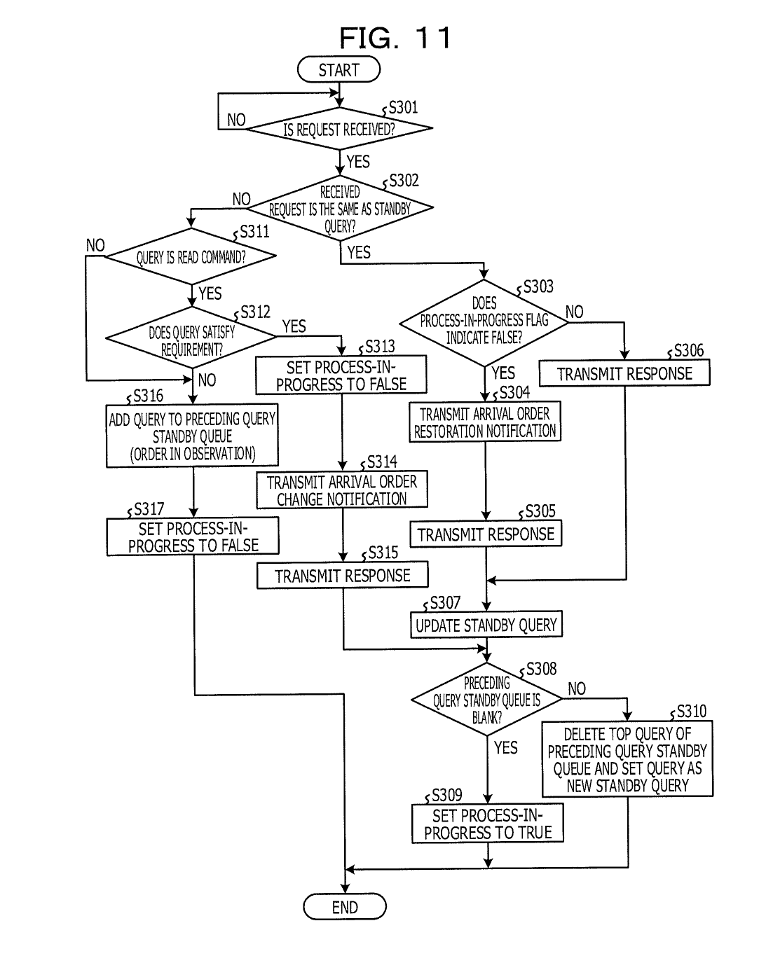

FIG. 11 is a flowchart of a process of simulating an operation of the DB server according to the second embodiment. As illustrated in FIG. 11, when receiving a request from the verification AP server 50 (Yes in S301), the determining unit 24a of the DB server simulator 24 determines whether the received request matches the standby query of the queue management table 15 (in S302).

When the determining unit 24a determines that the received query matches the standby query (Yes in S302), the transmitter 24b determines whether the process-in-progress flag indicates false (in S303).

When the transmitter 24b determines that the process-in-progress flag indicates false (Yes in S303), the transmitter 24b transmits, to the verification AP server 50, an arrival order restoration notification that indicates that the order in which requests arrive in the verification is restored to the order in which the requests arrive in the observation (in S304). Furthermore, the transmitter 24b identifies a response corresponding to the received query from the packet capture table 13 and transmits the response to the verification AP server 50 (in S305). The process of S304 may be executed before the process of S305. The process of S305 may be executed before the process of S304.

On the other hand, when the transmitter 24b determines that the process-in-progress flag does not indicate false (No in S303), the transmitter 24b identifies a response corresponding to the received query from the packet capture table 13 and transmits the response to the verification AP server 50 (in S306).

After S305 or S306, when the transmitter 24b transmits the request, the determining unit 24a updates the standby query of the queue management table 15 (in S307). Subsequently, the determining unit 24a determines whether the preceding query standby queue of the queue management table 15 is blank (in S308). When the determining unit 24a determines that the preceding query standby queue of the queue management table 15 is blank (Yes in S308), the determining unit 24a sets the process-in-progress flag to true (in S309). Specifically, although the order in which the requests arrive in the verification was different from the order in which the requests arrive in the observation, the determining unit 24a determines that the order in which the requests arrive in the verification is restored to the same order as the observation.

On the other hand, when the determining unit 24a determines that a query is stored in the preceding query standby queue of the queue management table 15 (No in S308), the determining unit 24a deletes a top query among queries stored in the preceding query standby queue and registers the query as a new standby query (in S310).

When the determining unit 24a determines that the received query is not the same as the standby query (No in S302), the determining unit 24a determines whether the received query is a read command (in S311). Specifically, the determining unit 24a determines whether an SQL statement described in the received query is an SQL statement to be used to read a table.

When the determining unit 24a determines that the received query is the read command (Yes in S311), the determining unit 24a determines whether the received query satisfies a requirement for transmission without waiting for the reception of a preceding query (in S312). For example, the determining unit 24a references a common table with a table referenced by the received query among queries arranged in order from the standby query to the received query. Then, the determining unit 24a uses the query analysis table 14 and the like to determine whether a write command that is a successful query exists.

When the determining unit 24a determines that the received query satisfies the requirement for the transmission without waiting for the reception of the preceding query (Yes in S312), the determining unit 24a sets the process-in-progress flag to false (in S313). Specifically, the determining unit 24a determines that the request is received in a different order from the production environment.

The transmitter 24b transmits, to the verification AP server 50, an arrival order change notification that indicates that the order in which requests arrive is different from the order in which the requests arrive in the observation (in S314). Furthermore, the transmitter 24b identifies a response corresponding to the received query from the packet capture table 13 and transmits the response to the verification AP server 50 (in step S315). After that, the determining unit 24a executes S308 and later. The process of S314 may be executed before the process of S315. The process of S315 may be executed before the process of S314.

When the determining unit 24a determines that the received query does not satisfy the requirement for the transmission without waiting for the reception of the preceding query (No in S312), the determining unit 24a causes the received query to be stored in the preceding query standby queue of the queue management table 15 (in S316). Subsequently, the determining unit 24a sets the process-in-progress flag to false (in S317) and terminates the process.

When the determining unit 24a determines that the received query is not the read command (No in S311), the determining unit 24a executes S316 without executing S312.

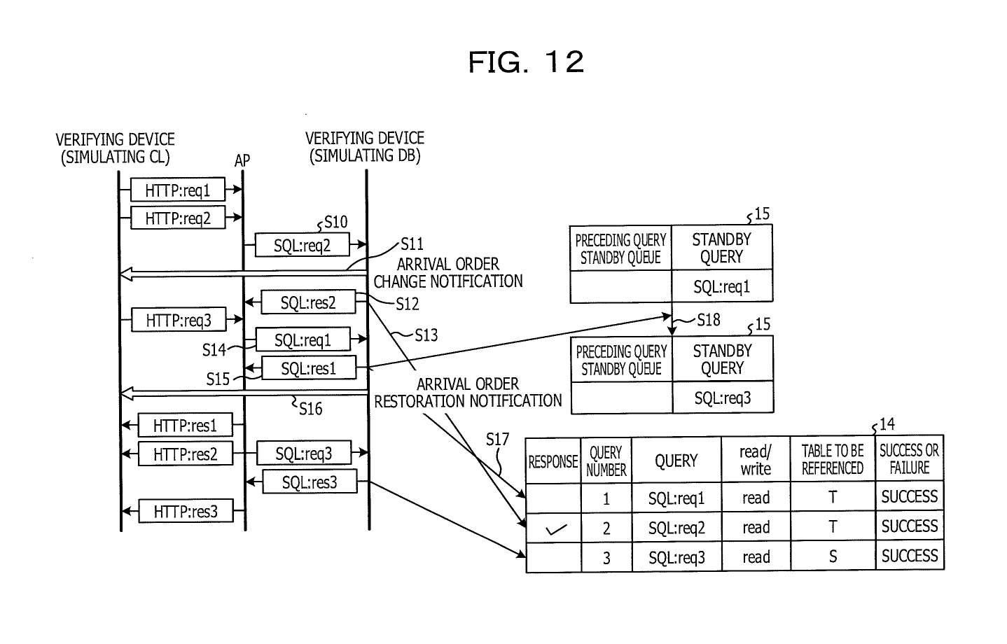

Next, a specific example of a process to be executed by the verifying unit 10 according to the second embodiment when the order in which requests arrive in the verification is different from the order in which the requests arrive in the observation is described. FIG. 12 is a diagram describing the process to be executed by the verifying device according to the second embodiment. Although query names are registered in the queue management table 15, the following description assumes that queries may not indicate the queries themselves and may indicate the query names.

As illustrated in FIG. 12, the verifying device 10 references the query analysis table 14 and stores “SQL:req1” in the standby query of the queue management table 15. In this state, the verifying device 10 receives “SQL:req2” from the verification AP server 50 (in S10).

Since the standby query “SQL:req1” of the queue management table 15 does not match the received query “SQL:req2”, the verifying device 10 transmits the arrival order change notification to the verification AP server 50 and the client simulator 23 (in S11).

Subsequently, the verifying device 10 determines whether the received query satisfies the requirement for the transmission without waiting for the reception of a preceding query.

Specifically, the verifying device 10 references the query analysis table 14 and identifies that the received query “SQL:req2” is a read command. Furthermore, the verifying device 10 references the query analysis table 14 and identifies that a table to be referenced by the received query “SQL:req2” is a table T and that a table to be referenced by the standby query “SQL:req1” is also the table T. Then, the verifying device 10 references the query analysis table 14 and identifies that the standby query “SQL:req1” is the read command that is a successful query.

As a result, the verifying device 10 determines that the received query is the read command and that a preceding query registered in the standby query is a successful query that is a read command that accesses the same table as the received query to be referenced. Then, the verifying device 10 determines that a response to the received query is to be transmitted.

Thus, the verifying device 10 transmits the response “SQL:res2” to the “SQL:req2” to the verification AP server 50 (in S12). Then, the verifying device 10 sets a flag in a “response” corresponding to the query “SQL:req2” of the query analysis table 14 (in S13).

After that, the verifying device 10 receives “SQL:req1” from the verification AP server 50 (in S14). Since the standby query “SQL:req1” of the queue management table 15 matches the received query “SQL:req1”, the verifying device 10 transmits the response “SQL:res1” to the received query “SQL:req1” to the verification AP server 50 (in S15).

Subsequently, the verifying device 10 transmits the arrival order restoration notification to the client simulator 23 and the verification AP server 50 (in S16). Then, the verifying device 10 sets a flag in a “response” corresponding to the query “SQL:req1” of the query analysis table 14 (in S17).

After that, the verifying device 10 references the query analysis table 14 and determines that the next query is “SQL:req2”. However, since “SQL:req2” is already received and the response to “SQL:req2” is already transmitted, the verifying device 10 stores the next query “SQL:req3” in the standby query (in S18).

In this state, the verifying device 10 receives “SQL:req3” from the verification AP server 50, the standby query “SQL:req3” matches the received query “SQL:req3”, and thus the verifying device transmits the response “SQL:res3” to the verification AP server 50.

If the order in which requests arrive in the verification is different from the order in which the requests arrive in the observation and it is possible to transmit a response regardless of the order, the verifying device 10 may transmit the response. Thus, a time for the verification process may be reduced, compared with a case where responses wait to be transmitted until the order in the verification becomes the same as the order in the observation. In addition, it is possible to prevent the occurrence of a failure, caused by the order of arrival of requests, of the verification while the time for the verification is reduced.

The verifying device 10 simulates operations of the client terminals and thereby reproduces the issuance of HTTP requests according to the observation. Thus, if the order in which responses to input requests are transmitted changes, the verifying device 10 may predict that the change is caused by a change in the order of DB queries. Specifically, the verifying device 10 may determine that the cause of the change in the order of arrival of the requests is highly likely to be a state of a network, a state of a server, or the like that is not related to a change of a program.

The verifying device 10 may transmit the arrival order change notification before transmitting a response to a request that has arrived in the verification in a different order from the observation. As a result, an operator who performs the verification may easily identify a request that has arrived in a different order from the observation and may easily identify a time when the order is changed, and a time for the determination of the cause may be reduced.

### Third Embodiment

Although the embodiments are described above, the disclosure may include other various embodiments.

For example, until the standby query arrives, the verifying device 10 according to the first embodiment does not transmit a response to another query received before the arrival of the standby query. In this case, the standby query may wait to be transmitted for a long time due to an error of a program of the verification AP server 50 or the like or may not be transmitted due to the error or the like. In such a case, the verifying device 10 according to the first embodiment continuously waits for arrival of the standby query and does not terminate the verification process and does not even delay the verification process.

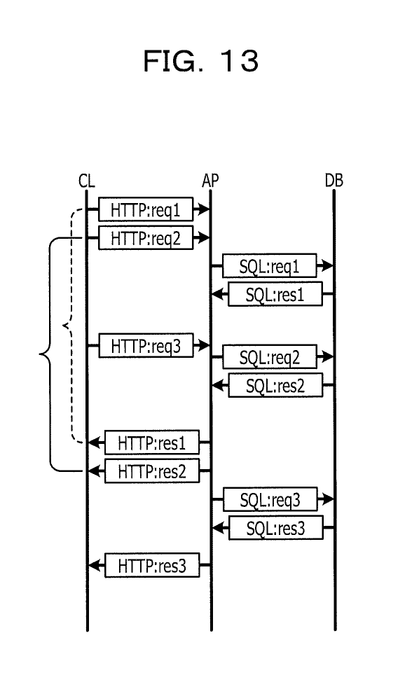

The verifying device 10 may use a method illustrated in FIG. 13 to avoid the aforementioned deadlock state. FIG. 13 is a diagram describing the method for avoiding a deadlock. For example, the verifying device 10 calculates an upper limit on a time for waiting for an SQL request from relevance of an event. If the verifying device 10 does not receive an SQL request until the upper limit elapses, the verifying device 10 transmits a response after the elapse of the upper limit. In this case, the verifying device 10 may transmit the response to the unreceived SQL request, transmit a notification indicating that the SQL request is not received, and transmit an error notification.

The example illustrated in FIG. 13 assumes that the verifying device 10 does not receive “SQL:req1” in the verification environment. In this case, the verifying device 10 identifies, from information obtained in the observation, that HTTP requests transmitted before the transmission of “SQL:req1” are “HTTP:req1” and “HTTP:req2”. As a result, the verifying device 10 determines that “SQL:req1”, “HTTP:req1”, and “HTTP:req2” are highly likely to relevant with the event.

Then, the verifying device 10 references the packet capture table 13 and calculates a longer one of a time period of (a transmission time of HTTP:req1−a transmission time of HTTP:res1) and a time period of (a transmission time of HTTP:req2−a transmission time of HTTP:res2) in the observation. Subsequently, the verifying device 10 calculates a certain factor of the calculated longer time period (TTT) as the upper limit.

As a result, the verifying device 10 may avoid a deadlock state and continue to execute the verification process. The verifying device 10 may prevent an excessive reduction in the upper limit by multiplying the calculated longer time period by the certain factor and suppress a risk that a process that is originally successfully executed may fail.

The second embodiment describes the example in which the verifying device 10 references a common table with a table referenced by a received query among queries arranged in order from the standby query to the received query and determines whether a write command that is a successful query exists. The requirement for the determination, however, is not limited to this.

For example, if the standby query that references the same table as a table to be referenced by the received query does not exist, the verifying device 10 may determine that a response to the received query is to be transmitted without waiting for the reception of the standby query. In this manner, the verifying device 10 may set an arbitrary requirement that does not cause an unreceived preceding query to affect a succeeding query.

The verifying device 10 may transmit a response after receiving a preceding query for an application using a data warehouse for integrating a plurality of DBs and treating the DBs as one DB or an application for providing a plurality of inquiries and returning a result returned first, in the same manner as the first embodiment.

In addition, the constituent elements of the illustrated devices are functionally conceptual and may not be physically configured as illustrated in the drawings. The separations and integrations of the devices are not limited to those illustrated in the drawings. Specifically, all or a part of the devices may be functionally or physically separated or integrated on an arbitrary basis, based on loads applied to the devices and usage statuses of the devices. In addition, all or a part of the processing functions of the devices may be achieved by a CPU or a program to be analyzed and executed by the CPU, or may be achieved as hardware by a wired logic.

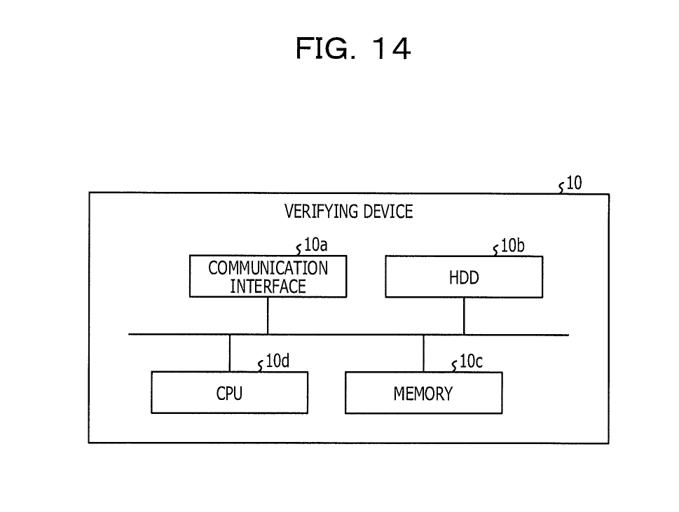

FIG. 14 is a diagram illustrating an example of a hardware configuration. As illustrated in FIG. 14, the verifying device 10 includes a communication interface 10a, a hard disk drive (HDD) 10b, a memory 10c, and a central processing unit (CPU) 10d. In addition, the units illustrated in FIG. 14 are coupled to each other by a bus or the like.

The communication interface 10a is an interface configured to control communication with another device and is a network interface card, for example. The HDD 10b stores the database and a program that causes the functions illustrated in FIG. 2 and the like to be operated.

The CPU 10d reads, from the HDD 10b or the like, the program for executing the same processes as the processing units illustrated in FIG. 2 and the like, loads the read program into the memory 10c, and thereby executes a process for executing the functions described with reference to FIG. 2 and the like.

Specifically, the process executes the same functions as the processing units included in the verifying device 10. Specifically, the CPU 10d reads, from the HDD 10b or the like, the program that has the same functions as the packet capturing unit 21, the capture analyzer 22, the client simulator 23, the DB server simulator 24, the verifying unit 25, and the like. The CPU 10d executes the process for executing the same processes as the packet capturing unit 21, the capture analyzer 22, the client simulator 23, the DB server simulator 24, and the verifying unit 25.

In this manner, the verifying device 10 operates as an information processing device configured to execute the verification process by reading and executing the program. In addition, the verifying device 10 may achieve the same functions as the aforementioned embodiments by causing a medium reading device to read the aforementioned program from a recording medium and executing the program. The program according to the other embodiment is not limited to the program to be executed by the verifying device 10. For example, the disclosure is applicable to a case where another computer or another server executes the program or a case where the other computer and the other server collaborate with each other and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method to be executed by a processor included in a verifying device configured to verify a program executed by a device, the information processing method comprising:
storing order information indicating an order in which a plurality of packets are received by the verifying device;
receiving packets transmitted by the device according to the program executed by the device; and
controlling a timing to transmit a response to each of the received packets based on the order information.

2. The information processing method according to claim 1,
wherein the controlling includes transmitting a response to a packet received by the receiving to the device when the received packet is a packet which is expected to be received according to the order information.

3. The information processing method according to claim 2, further comprising:
storing information of the received packet as information of a standby packet that waits for a response process when the received packet is not the packet which is expected to be received according to the order information;
determining whether the information of the standby packet is stored when the received packet is the packet which is expected to be received according to the order information; and
specifying the standby packet as the packet to be received from the device when it is determined that the information of the standby packet is stored.

4. The information processing method according to claim 2,
wherein the receiving includes receiving requests that have been transmitted by the device based on a request received from a client device and are requests to access a storage device.

5. The information processing method according to claim 4, further comprising:
determining whether the received packet is the access request and satisfies a requirement for transmission without waiting for the reception of the specified packet when the received packet is not the packet which is expected to be received according to the order information; and
transmitting the response to the received packet to the device to be verified when it is determined that the received packet is the access request and satisfies the requirement.

6. The information processing method according to claim 5, further comprising:
transmitting, to the client device, an order change notification indicating that an order in which the access requests are received is changed when the response to the received packet is transmitted to the device before the transmission of a response to the packet which is expected to be received according to the order information.

7. The information processing method according to claim 6, further comprising:
transmitting, to the client device, an order restoration notification indicating that an order in which the access requests are received is restored when a packet received after the transmission of the order change notification is determined to be received in the order indicated by the order information.

8. The information processing method according to claim 4, further comprising:
calculating, based on the order information, a response time from a time when the client device transmits the request to a time when a response to the request is received when the received packet is not the packet which is expected to be received according to the order information; and
transmitting the response to the received packet to the device to be verified after a predetermined time calculated using the response time elapses.

9. A verifying device configured to verify a program executed by a device, the verifying device comprising:
a memory; and
a processor coupled to the memory and configured to:
store a packet to be received from the device from among the plurality of packets based on order information indicating an order in which a plurality of packets are received by the verifying device;
receive packets transmitted by the device according to the program executed by the device; and
control a timing to transmit a response to each of the received packets based on the order information

10. The verifying device according to claim 9, wherein the processor is further configured to transmit a response to a packet received by the processor to the device when the received packet is a packet which is expected to be received according to the order information.

11. The verifying device according to claim 10, wherein the processor is further configured to:
store information of the received packet as information of a standby packet that waits for a response process when the received packet is not the packet which is expected to be received according to the order information;
determine whether the information of the standby packet is stored when the received packet is the packet which is expected to be received according to the order information; and
specify the standby packet as the packet to be transmitted by the device when it is determined that the information of the standby packet is stored.

12. The verifying device according to claim 10, wherein the processor is further configured to receive requests that have been transmitted by the device based on a request received from a client device and are requests to access a storage device.

13. The verifying device according to claim 12, wherein the processor is further configured to:
determine whether the received packet is the access request and satisfies a requirement for transmission without waiting for the reception of the specified packet when the received packet is not the packet which is expected to be received according to the order information; and
transmit the response to the received packet to the device when it is determined that the received packet is the access request and satisfies the requirement.

14. A non-transitory computer-readable storage medium storing a program that causes a computer to execute a process, the process comprising:
storing order information indicating an order in which a plurality of packets are received by the verifying device;
receiving packets transmitted by the device according to the program executed by the device; and
controlling a timing to transmit a response to each of the received packets based on the order information.
